(19) United States
(12) Patent Application Publication
(10) Pub. No.: US 2007/0160971 A1
(43) Pub. Date: Jul. 12, 2007

(54) Method for Automated Examination Testing and Scoring

(76) Inventors: Paul F. Caldera, Falmouth, MA (US); Charles J. Ouellette, Lunenberg, MA (US); Carmen T. Reitano, Haverhill, MA (US); Walter E. Cheney, Dover, MA (US); Geoffrey D. Cronin, Concord, MA (US)

Correspondence Address: WHITE & FUDALA, 57 BEDFORD STREET, SUITE 103, LEXINGTON, MA, 02420, US

(21) Appl. No.: 11/306,849

(22) Filed: Jan. 12, 2006

(51) Int. Cl. G09B 7/00; G09B 3/00

(52) U.S. Cl. 434/353

(57) ABSTRACT

A software based method of automatically recording and scoring tests is practiced on a system including a computer, a digital pen and a sheet of digitized paper, the method first establishing a number of virtual fields on the digitized paper, each which may contain either one allowable mark, or a multiplicity of allowable marks, marking of the paper using the digital pen, and for each such mark determining the field in which the mark is made, if the field may contain only one allowable mark, then recording that mark, and if the field may contain more than one allowable mark, then using character recognition means to identify the mark, and then calculating a test result based on the marks made, the characters corresponding to each, and a scoring protocol.

### BACKGROUND OF THE INVENTION

The present invention is an innovative and unique system for automating the scoring and data capture of written test results. The invention is especially applicable to testing in which a tester, typically a teacher, examines a testee, typically a student. In this paradigm the teacher asks the student to respond to a series of queries. The teacher then marks a digitized test form with a digital pen, both of which are well known in the prior art. A computer program then analyses the marks and evaluates the student performance.

The most innovative feature of the present invention is the use of virtual geometric fields on the test form. The use of this mechanism allows for rapid and especially accurate interpretation by the software of the characters input.

The present invention was developed during the development of automated means for test scoring in connection with the early assessment of student performance. This invention is intended to partially automate the student testing system know as Dynamic Indicators of Basic Early Literacy Skills™, or DIBELS®. DIBELS is a set of tests calculated to evaluate the literacy skills of children. It contains such tests as Oral Reading Fluency, Retell Fluency, Nonsense Word Fluency, Phoneme Segmentation Fluency, Letter Naming Fluency, and Initial Sound Fluency. DIBELS is the de facto standard for the U.S. Department of Education's Early Childhood Educator Professional Development Program.

DIBELS tests are evidence-based, individually administered measures of early literacy development built upon over 25 years of proven scientific research. Their measures address the essential early literacy domains discussed in both the National Reading Panel (2000) and National Research Council (1998) reports, assessing student development of phonological awareness, alphabetic understanding, and automaticity and fluency.

To date, few choices have existed for teachers and schools to effectively and efficiently collect and manage assessment data. Yet, data collection and data management are critical success factors for providing ongoing student performance assessment and for reporting progress by individual student, or by class, school, or district. Most often, teachers record assessment scores by notating results by hand, in real time, on a pre-printed score sheet. Ideally, score sheets are then collected and forwarded to administrative staff who re-key data into a Data Management System for ongoing management and reporting. In most cases, however, the burden of re-keying individual assessment data falls to the teacher. Aside from the inefficiencies of this process and its increased opportunities for human error, the administrative function remains the constraining factor and is viewed as a burden on already limited school resources. In fact, many schools report that the administrative function does not occur, relegating these otherwise meaningful, actionable measures to a file drawer rather than a robust online management and reporting system.

The solution described in the present invention is truly unique. A data collection process has been designed by which proven and familiar pen-on-paper scoring practices are retained, practices already employed in schools all across America.

The present solution was made possible by the recent availability of digital pen technology. Using this technology the present invention allows all data to be captured digitally, in real time, while automatically uploading assessment data to an online data management system. There is virtually no learning curve for personnel using the present invention. The fundamentals of the existing, proven manual process are, to the greatest extent possible, retained.

The elegance and simplicity of the present invention is deceiving. While easy to use, there is no more technologically advanced solution currently available for data capture. The present invention features high-speed, high resolution digital imaging and image processing technologies. Yet, despite the level of technology within, the digital pen looks and feels like an ordinary ballpoint pen. There are no buttons to press, no software to learn, and no screens to scroll or navigate.

Data transfer is conducted automatically and requires no interaction by school personnel. This is achieved using Microsoft .NET technology and Web services. These small, reusable applications are written in XML, a universal language for data exchange, allowing data to be securely communicated across the Internet between otherwise unconnected sources. Once assessment data is uploaded, actual hand-written notations originating with the assessment collection process are also captured and uploaded. Teachers and administrators can access intuitive, actionable reports and performance measurement tools just as they do today, as well as view digital images of their original score sheets.

### SUMMARY OF THE INVENTION

It is an object of this invention to provide an automated method for recording and processing the results of written tests.

In accordance with one aspect of the invention the method is software based and practiced on a system having a computer, a digital pen and a sheet of digitized paper.

In accordance with a second aspect of the invention the method establishes a number of virtual fields, each identified by a location and extent on the digitized paper, and each which may contain either one or more allowable marks.

In accordance with a third aspect of the invention the paper is marked by a tester using the digital pen;

In accordance with a fourth aspect of the invention, for each such mark the software determines the field in which the mark is made.

In accordance with a fifth aspect of the invention, if the field may contain only one allowable mark, and the tester has made a mark in that field, then the field is identified as containing the allowable mark.

In accordance with a sixth aspect of the invention, if the field may contain more than one allowable mark, and the field has been marked, character recognition means is used to identify the mark, which is then recorded.

In accordance with a seventh aspect of the invention, a test result is calculated based on the marks made, the characters corresponding to each, and a scoring protocol.

In accordance with an eighth aspect of the invention method further includes the steps of manually scoring of the test by a tester, viewing by the tester of the calculated test results on the computer monitor and comparing the manual scoring results with the calculated test results.

In accordance with a ninth aspect of the invention the method further includes the correcting by the tester of the calculated test results if they are found to be in error.

In accordance with a tenth aspect of the invention the character recognition means further include optical character recognition of the entire alpha-numeric character set.

In accordance with a tenth aspect of the invention the character recognition means further include determining whether the mark is substantially vertical, horizontal, or angled.

In accordance with an eleventh aspect of the invention the digitized paper form contains a number of lines, each line containing a number of characters.

In accordance with a twelfth aspect of the invention the tester prompts the testee, eliciting a spoken response which is recorded by the tester.

In accordance with a thirteenth aspect of the invention the tester marks the form, indicating the testee's response.

In accordance with a fourteenth aspect of the invention the marks made by the tester are analyzed by the computer program and a test result generated in accordance with a protocol.

In accordance with a fifteenth aspect of the present invention successive test forms are recorded and evaluated at successive time intervals and a report showing comparative progress is generated.

In accordance with a sixteenth aspect of the invention the marks analyzed include members of the group consisting of slashes, strike-throughs, checks, underlines, circles, and brackets, and the character recognition system for this group does not require optical character recognition of the entire alphanumeric character set.

### BRIEF DESCRIPTION OF DRAWINGS

The invention will be more fully described in the following detailed description in conjunction with the drawings in which:

FIG. 1 depicts a system in which the present method is practiced.

FIG. 2 depicts the LNF test sheet of the present invention.

FIG. 3 depicts the PSF test sheet of the present invention.

FIG. 4 depicts the ORF test sheet of the present invention.

FIG. 5(a) depicts the fields on a line of FIG. 2.

FIG. 5(b) depicts the fields on another line of FIG. 2.

FIG. 6 depicts a generalized version of the present invention.

### DESCRIPTION OF THE PREFERRED EMBODIMENTS

The present invention further uses technology such as that developed by Logitech, sold under the trademark “Logitech io Personal Digital Pens”. Using an optical sensor, the digital pen optically records the marks made by the pen as the ink flows onto the paper. A built-in processor digitizes the marks, storing up to 40 pages in memory between downloads. Based on functionality from Anoto, the Logitech io Digital Pen encodes on the basis of microscopic dots printed on the paper. Since it always knows exactly where on the paper each mark is made, the location, as well as the nature of the markings made, can be stored for editing or interpretation at a later time.

The present invention thus further utilizes another prior art device, the encoded paper sold by Anoto Group AB, a Swedish high-tech company. This encoded paper provides the position information which allows the Logitech io Digital Pen to read its position on the paper as it is used to write characters on the paper, in addition to recording the characters themselves in a series of pen strokes.

It should be noted that other companies are producing these products, as well as the two named above. The development work on this invention was done using the named products, however.

In the first preferred embodiment the present invention is an automated system in which the teacher, using the digital pen, fills out the DIBELS answer sheets on the encoded paper. The digitized pen strokes are then stored digitally, transferred to a computer, interpreted by a computer program, and used to evaluate the student's performance. The teacher may use the computer to view the test results of each test sheet, and make corrections to the evaluation of that sheet, if required.

The teacher simply removes the cap to activate the pen. The pen contains ink, so teachers score DIBELS assessments just as they do today. A tiny camera inside the pen registers its movement across the surface of the paper and stores these movements as a series of map coordinates. These coordinates correspond to the exact location and real time movement of the pen on the scoring sheet, as a result of a pattern of very small dots printed onto ordinary paper stock. To the human eye, the pattern looks like a light shade of gray, yet the dot pattern and its functionality are unique and specific to each individual assessment score sheet. The pen stores a full megabyte of pen stroke information, so hundreds of assessments can be captured before the pen is cradled for automatic data upload.

Data transfer is conducted automatically and requires no interaction by the teacher. Once assessment data is uploaded, actual hand-written notations originating with the assessment collection process are also captured and uploaded. The uploaded data is then immediately analyzed and test results calculated. The teacher may manually calculate test scores, and compare the manual results with results calculated by the system.

System Configuration

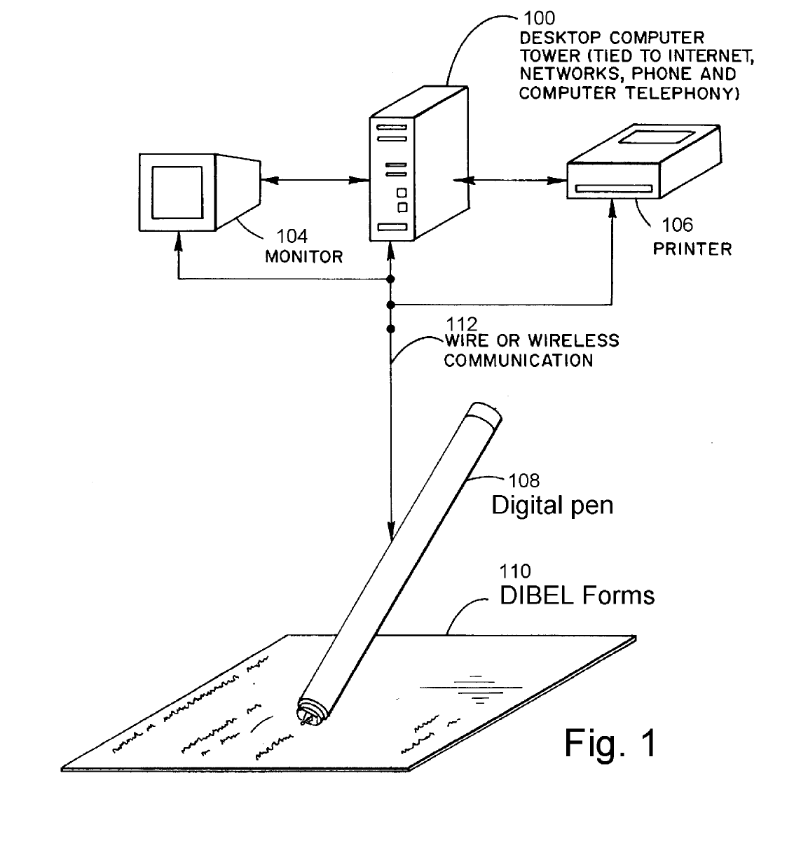

The preferred embodiment utilizes a system as shown in FIG. 1. The system includes a personal computer 100, monitor 104, printer 106, a digital pen 108, and digital paper form 110. Other systems on which the system can be practiced include a computer network to which the system of FIG. 1 is connected. The basic requirements of a system include the digital pen and digitized paper form, and connection of the pen to a computer system. The connection may be either by wire, or using a wireless interconnection. In addition, the computer program that implements the present method must be resident on the computer system.

Typically the teacher will also be located adjacent to the computer system, or at least within reach of a monitor and computer keyboard and mouse, so that the results of the test can be viewed after input to a particular test form has been completed.

### DETAILED DESCRIPTION OF THE PREFERRED EMBODIMENTS

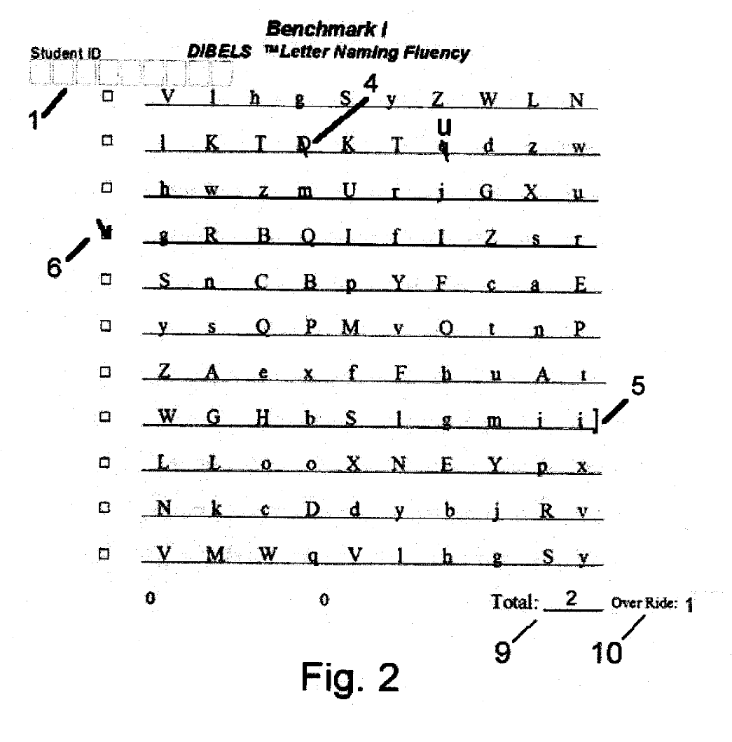

Several of the standard DIBELS test forms, modified for use with the present invention, and printed on digitized paper are shown in FIGS. 2 through 5(B). These digitized paper sheets allow the teacher conducting the DIBELS test to mark the sheet with a digital pen and read the markings into the computer with which the pen communicates. The digitized Test Sheets are specially-designed digitized sheets which permit the precise location of the tip of the digital pen to be determined automatically.

The digitized test sheets of this invention are used in a variation of the standard DIBELS manual scoring process. An obvious benefit of the present invention is that the teacher is not required to tally errors, words processed, or phonemes processed, as the automated system can easily perform this function, and perform it without errors.

In addition the present system stores results in successive tests on each student, and can generate various reports showing the progress of the students. The following paragraphs describe particular implementations of the present method as it applies to tests which assess the literacy levels of young children.

Letter Naming Fluency—LNF Test

The DIBELS LNF test demonstrates the basic concepts involved in the application of the present invention.

The operation of the automated scoring version of the LNF test may be understood by referring first to FIG. 2, which is the digital form which corresponds to the prior art form provided by DIBELS.

Referring now to FIG. 2, and as in all the other tests, the teacher first fills out the student ID number 1 in the boxes at the top of the sheet. The teacher begins by stating the instructions to the student as they appear in Page 4 of the DIBELS First Grade Scoring Booklet which is attached hereto as Appendix A.

The test begins with the student speaking the first letter. If the student pronounces the name of the letter properly the teacher takes no action, and the student proceeds to the next letter. If the student makes a mistake, the teacher writes a slash character “\” 4 though the offending letter. The student may be given the opportunity to correct the mistake, as in the subsequent tests, and described infra.

If the student skips a line, the teacher writes a check character 6 in the box to the left of the line.

At the expiration of the time limit established for this test the teacher indicates the last letter the student completed by writing a bracket “]” 5 after that letter.

After the characters written by the digital pen are input to the program, the following processing takes place:

The Student ID number is stored in the system together with the time and date to identify the test result. An OCR program converts the characters in the Student ID fields to data, which is stored in the computer memory.

Each time a slash is detected the program notes the field location of the slash, and determines the word and phoneme corresponding. This data is stored in computer memory, and the error count for this test is incremented by one.

If the self-correction character is detected from the pen strokes, the corresponding phoneme is annotated accordingly. The error count is decremented, and the self-correction count is incremented.

When the bracket is detected the location is used by the program to determine the number of words processed. This total is stored. The teacher, seated at the computer, is shown a software version of the LNF form on the screen. The totals are shown in the field appearing at ref. no. 9, and the number of self-corrections at ref. no. 10. The teacher may choose to correct these figures if they are determined to be in error.

The test results may then be printed. These include total words processed, number of errors made, and number of self-corrections made.

The advantages of this automated system include the automatic calculations of total errors and self-corrections, number of words processed within the testing period, and automatic storage of these parameters. In addition, the ability of the teacher to manually check the calculations of the computer lend further credibility to the results of the optical pen input and character recognition software.

After successive testing of these words over a period of time, the computer system may be used to print out comparative results in various forms, including graphic forms, which show the progress of the child in performing this test.

Phoneme Segmentation Fluency—PSF Test

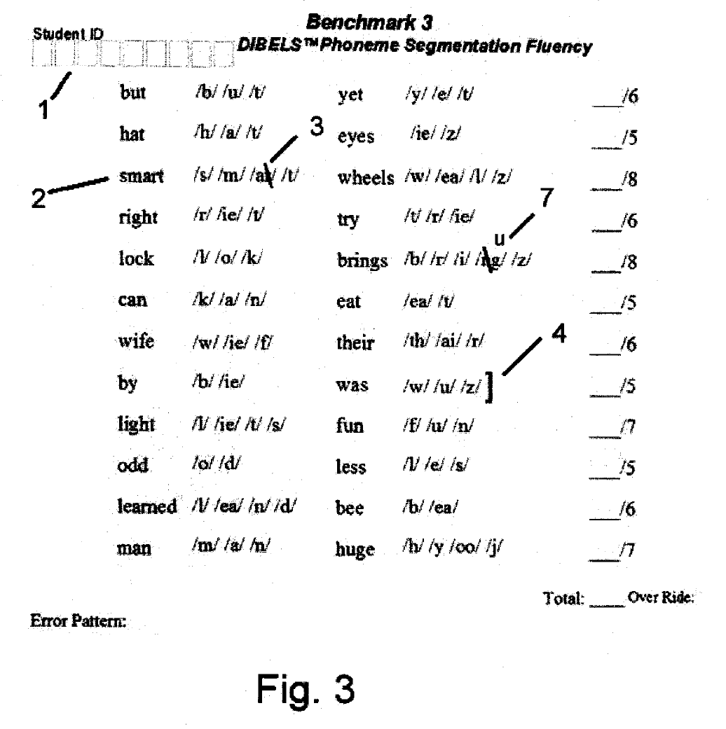

The PSF test demonstrates other features of the present invention. Referring next to FIG. 3 the modified test sheet for the DIBELS Phoneme Segmentation Fluency (PSF) test is shown. Referring now to this figure, and as in all the other tests, the teacher first fills out the student ID number 1 in the boxes at the top of the sheet.

The test begins with the teacher speaking the first word, in this case “but”. After the teacher says the first word the student says the phonemes which make up the word. For instance, the word “smart” 2 in line three of FIG. 3 contains the phonemes /s/, /m/, /ar/, and /t/. If the student pronounces them correctly the teacher goes on to the next word, in this case, “try”. If the student mispronounces the phoneme, however, the teacher marks a slash “\” 3 through the phoneme on the Test Sheet to indicate an error. The teacher may then write the phoneme incorrectly pronounced by the student above the phoneme in question. In the case of the word “brings”, appearing in column two, line five of this figure, it is assumed that the student pronounced “n” instead of “ng”. Accordingly, the teacher wrote the phoneme “n” 7 above the incorrectly pronounced phoneme, as well as writing a slash through the phoneme on the form .

As in all the other tests, the data is stored in the digital pen as the teacher marks the test form, and the contents of the pen are downloaded at the end of a test, when a test page has been completely filled out. The data is then downloaded into the computer from the pen, which is cleared of data. The computer then begins its processing.

As the characters which have been written by the digital pen are input to the computer program, the following processing takes place: (a) the Student ID number is stored in the system together with the time and date to identify the test result; (b) each time a slash is detected the program notes the virtual field location of the slash, and determines the word and phoneme corresponding. This data is stored, and the error count for this test is incremented by one.

As in the prior test, the computer program computes a test score, which may then be manually checked by the teacher, and corrected by means of computer input if necessary.

The test results may then be printed. These include total words processed, number of phonemes processed, number of errors made, phonemes erroneously pronounced, and corresponding words.

Oral Reading Frequency—ORF Test

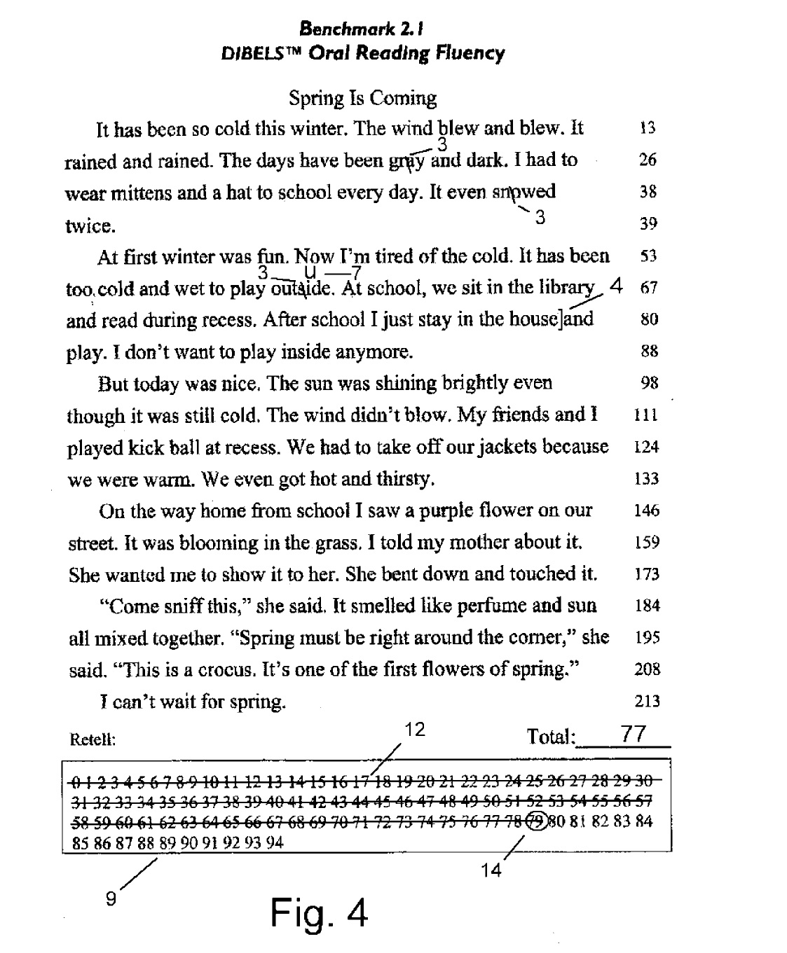

Referring next to FIG. 4 a final example of the present invention implemented for the DIBELS ORF test is shown. Although DIBELS contains other specific forms of tests, the principles demonstrated by the three tests reviewed here are sufficient to show and disclose the method of the present invention.

The ORF test is implemented by the student reading a story, which appears as lines of text. If the student mispronounces a word, the teacher writes a “slash” 4 through the mispronounced words. As in other tests, the student may, within a short period of time, re-pronounce the word, and, if now correct, the teacher writes a “u” 7 above the mispronounced word indicating a self-correct. When the session terminates the teacher so indicates by writing a “bracket” 4 at the end of the last word pronounced.

The total number of error-free words pronounced is recorded by the system at the end of the session, and this will be displayed on the computer monitor used by the teacher during the performance of the test, in this case 77. The number of self-corrections may also be shown, although it is not shown in this figure.

Finally, the teacher is permitted to manually check the test results as calculated by the computer program, and, if incorrect, these may be corrected by the teacher by inputting the corrected number and using the override feature. The teacher may or may not want to write the total at the bottom of the form.

Program Implementation

The automation of the tests described above is implemented by a novel program organization directed toward the use of the digital pen and digitized paper as used herein.

The method is implemented by organizing the digitized paper into a number of geometric fields throughout the paper. These fields are physical locations on the paper where test result markings are intended to be written.

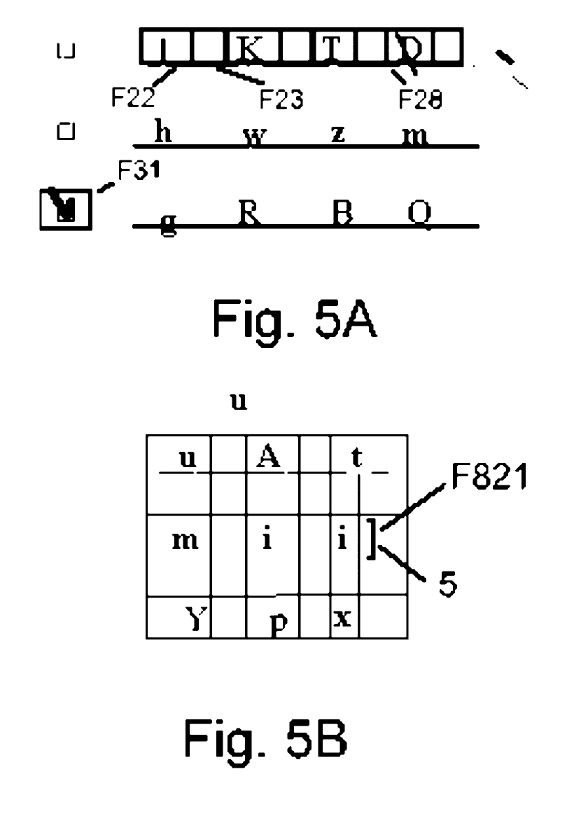

The concept may be understood by referring next to FIG. 5A, which is a detailed view of the test form shown in FIG. 2. This figure shows virtual geometric fields entitled F22, F23, F28, and F31. These fields appear as boxes in this figure, but they do not actually appear in the test form itself, but are, in effect, “invisible boxes”.

Upon further examination it will be seen that the fields are labeled according to the row and column on which the field appears. As an example field F23 contains data in the second row, third column of the form. All fields in the first column are configured to enclose the check boxes at the left side of the page.

They do, however, exist in the code of the program which processes the data input during the marking of the test forms by the teacher. When the teacher marks the test form in any way, the program determines in which of these invisible fields the pen strokes lie.

The field of “slash” pen stroke, for example, appears in field F28. Because the procedures for use of this form only permit a slash mark (or no mark at all) in this field, the program assumes that any mark within the field is a slash. Slash marks are only permitted in columns having even numbers. Examples of such fields include F22, F34, F48, etc.

Thus, once the teacher makes a mark in a field representing an even column number this mark is assumed to be a slash. Thus, no OCR identification of the mark is required in regard to these fields.

Similarly, the only marks allowed in fields representing the first column of the test sheet are check marks. Thus, if any mark appears in such fields, the mark is assumed to be a check, and no OCR identification is required in this case, either. These check mark fields include F11, F21, F31, etc.

It should be apparent now that the first digit following the “F” in the field designators represents the row number, while the second digit represents the column number. These designations are used only for convenience, and do not necessarily appear in this form in other embodiments of this system.

Referring next to FIG. 5B, the “bracket” character is used in this test to indicate the position of the last letter pronounced by the student. This “]” is written in the space following the letter. Spaces following letters are contained in fields representing odd numbered columns. Thus, any mark made in such a field is considered to be a bracket, since no other mark is permitted in these spaces. Thus, it is not necessary to perform OCR on these characters.

It should be noted that in the present embodiment the data read by the pen is not uploaded into the computer system for processing, but rather is stored in the digital pen for “batch” processing at the end of the test. Thus, the teacher will see the results of the calculations on the computer monitor only after the upload and calculations are complete.

In further embodiments of this invention a rudimentary form of character identification is made. For instance, in the case of a slash character, the character ID program may determine that the mark is more likely an angled line, rather than a straight line, to further protect against sloppy marking, such as marking a bracket too close to an even column number field. In either case, however, traditional OCR is not required to identify the character, thus reducing processing time for automated interpretation of the forms.

On the other hand, traditional OCR methods are required for fields such as the Student ID 1 fields as they appear in the forms of FIGS. 2-4.

Referring again to FIG. 3 a total 9 is automatically calculated by the system as soon as the test is completed. In the current embodiment the data from the digital pen is uploaded from the pen to the computer at test completion, either by an explicit command given the computer, or by docking the pen in its holder, depending upon the system used.

When the tester has thus notified the system of the end of testing of a particular form the uploaded data is then analyzed to arrive at a test score.

In the example of FIG. 3 the test score is calculated as a function of the number of phonemes tested, the number of errors encountered, and the number of self-corrections made. The exact scoring depends upon the test protocol used. In the present example the score may be calculated as the number of phonemes tested minus the number of uncorrected errors made.

A Generalized Embodiment of the Present Invention

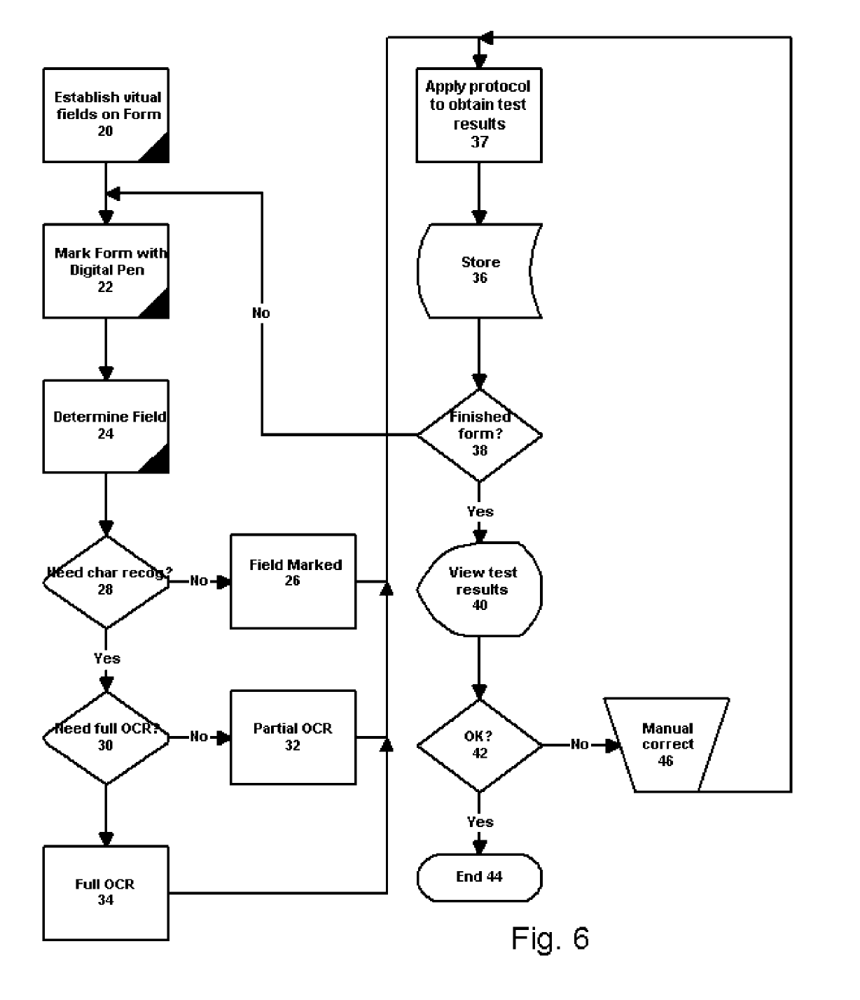

A more generalized implementation of this method, applicable to a wide variety of written tests, is shown in FIG. 6. This figure describes a system in which a tester and testee interact, and wherein the tester records the interactions by marking a digital form on digitized paper with a digital pen.

Referring now to this Figure, it is first noted that the method practiced on a system comprising a computer, a program residing on the computer, a digital pen and a sheet of digitized paper, as in all of the other embodiments. The tester has access to the computer in order to review the results of the tests as they are performed.

The program establishes a number of virtual fields 20 for each form, each field identified by a location and extent on the digitized paper, and each which may contain either one allowable mark, or a multiplicity of allowable marks. The fields are generally rectangular in shape, although in other embodiments the fields may be circular, or have other shapes. The marks made by the digital pen are effective in a particular field only if they lie within the extent of that field.

Next, the digital paper is marked by a tester using the digital pen 22. For each such mark a determination is made 24, by the program, of the field in which the mark is made.

For each field the program contains an indication of which marks are allowable in that field. If the field contains any marking at all, and the field is configured by the program so that it may contain only one allowable mark, then that mark is recorded 26. If, however, the field may contain more than one allowable mark, then a determination must be made of which mark was made before recording that mark.

Depending upon the scope of the marks allowable within the field, different types of analysis are made to determine which stroke was made. If, for instance, the stroke is limited to a few possibilities, such as either a vertical, horizontal, or angled mark, then a simplified character recognition process is used 32. If, however, a field may contain any alphanumeric character, then a full-blown OCR analysis must be done 34.

Once the marks are interpreted the program proceeds to calculate a test result based on the marks made, and the marks are converted to data and stored 36, a protocol for using those marks to compute one or more test results 37. These results are typically numeric, but not necessarily so. The protocol may be as simple as adding up marks which are in fields that designated them as errors.

At the conclusion of a test on a particular test sheet the tester may view the calculated test results on the computer monitor 40, which also displays the entire test sheet, marked by the tester, and also showing computed results. The tester may then compare the manual scoring results with the calculated test results 42. If they differ, the tester may then manually correct the calculated test results accordingly 46.

In still another embodiment of the invention the tester and testee are the same person. In this event the testee does not have the ability to correct the test results once the test is taken.

Although the DIBELS test protocol has been used as the preferred embodiment in the present invention, it is clear that the invention can be more broadly applied to a wide variety of Curriculum-Based Measurements (“CBM”). CBM is the method of monitoring student progress through direct, continuous assessment of basic skills. CBM is used to assess reading fluency and comprehension. Early literacy skills (phonics and phonological awareness) are similar measures and are downward extensions of CBM. CBM is an approved and standardized assessment practice based on over 25 years of scientific research.

Examples of CBM include, but are not limited to, DIBELS, Texas Primary Reading Inventory (TPRI)®, and AIMSweb®.

While the invention has been described with reference to specific embodiments, it will be apparent that improvements and modifications may be made within the purview of the invention without departing from the scope of the invention defined in the appended claims.

What is claimed is:

1. A software based method of automatically recording and scoring tests, the method practiced on a system comprising a computer, a digital pen and a sheet of digitized paper, the method comprising the following steps:
(a) establishing a multiplicity of virtual fields, each identified by a location and extent on the digitized paper, and each which may contain either one allowable mark, or a multiplicity of allowable marks;
(b) marking of the paper by a tester using the digital pen;
(c) for each such mark:
(i) determining the field in which the mark is made;
(ii) if the field may contain only one allowable mark, then recording that mark;
(iii) if the field may contain more than one allowable mark, then determining which mark was made by character recognition means, and recording that mark;
(d) calculating a test result based on the marks made, the characters corresponding to each, and a scoring protocol.

2. The method of claim 1, wherein the method further comprises the steps of:
(a) manually scoring of the test by the tester;
(b) viewing by the tester of the calculated test results on the computer monitor;
(b) comparing the manual scoring results with the calculated test results; and
(c) correcting by the tester of the calculated test results if they are found to be in error.

3. The method of claim 2, wherein the character recognition means further comprise optical character recognition of the entire alpha-numeric character set.

4. The method of claim 3, wherein the character recognition means further comprise determining whether the mark is substantially vertical, horizontal, or angled.

5. The method of claims 4, wherein the digitized paper comprises a form further comprising a multiplicity of lines, each line comprising a multiplicity of characters, the method further comprising the steps of:
(a) prompting by the tester of a response by a testee;
(b) speaking by the testee of the response;
(c) marking by the tester on the form indicating the testee's response;
(d) calculation and storage of the number of incorrectly spoken responses; and
(e) generation of reports of test results.

6. The method of claim 5, further comprising the steps of repetition of the steps (a) through (d) of the previous claim during subsequent test periods; and generation of reports showing the progress of the testee during all the test periods.

7. The method of claim 6, wherein the marks further comprise the group consisting of slashes, strike-throughs, checks, underlines, circles, and brackets, and wherein the character recognition does not comprise optical character recognition of the entire alphanumeric character set.

8. The method of claim 7, wherein the tester is a teacher and the testee is a student, and wherein each line on the form comprises one or more letters, the method further comprising the steps of:
(a) pointing by the student to a letter;
(b) speaking by the student of the letter;
(c) if any of the letters are incorrectly spoken then writing by the teacher of a slash through the corresponding letter;
(e) after the expiration of a test time limit the writing by the teacher of a bracket character at the end of the last letter spoken by the teacher;
(f) calculation and storage of the number of incorrectly spoken letters;
(h) generation and storage of a test score based on a test protocol.

9. The method of claim 7, wherein the tester is a teacher and the testee is a student, and wherein each line on the form comprises one or more words, and for each word one or more phonemes which make up the word, the method further comprising the following steps for each such word:
(a) speaking by the teacher of a word;
(b) speaking by the student of the phonemes making up the word;
(c) if any of the phonemes are incorrectly spoken then writing by the teacher of a slash through the corresponding phoneme;
(d) calculation and storage of the number of incorrectly spoken phonemes;
(e) generation and storage of a test score based on a test protocol.

10. The method of claim 7, wherein the tester is a teacher and the testee is a student, and wherein each line on the form comprises one or more nonsense words, and for each nonsense word one or more phonemes which make up the word, the method further comprising the following steps for each nonsense word:
(a) speaking by the student of the nonsense word;
(b) if any of the nonsense words are incorrectly spoken then writing by the teacher of a slash through the corresponding phoneme of the incorrectly spoken nonsense word;
(c) after the expiration of a test time limit the writing by the teacher of a bracket character at the end of the last word spoken by the teacher;
(d) calculation and storage of the number of incorrectly spoken phonemes;
(e) generation and storage of a test score based on a test protocol.

11. The method of claim 7, wherein the tester is a teacher and the testee is a student, and wherein each line on the form comprises one word, further comprising the steps of:
(a) for each line, the speaking by the teacher of the word;
(b) speaking by the student of a sentence using the word;
(c) writing by the teach of a line through a progressing number as each word in the sentence is spoken;
(d) for each word spoken by the teacher, calculation and storage of the number of words in the sentence using the word;
(e) generation and storage of a test score based on the number of words spoken and a test protocol.

12. The method of claim 7, wherein the tester is a teacher and the testee is a student, and wherein each line on the form comprises one or more words, the words forming sentences, the method further comprising the steps of:
(a) speaking by the student of a sentence;
(b) if the student does not know a particular word in the sentence, then drawing a slash through the word by the teacher;
(c) after the expiration of a test time limit the writing by the teacher of a bracket character at the end of the last word spoken by the student;
(d) calculation and storage of the number of words correctly spoken;
(e) generation and storage of a test score based on the number of words correctly spoken and on a test protocol.

13. The method of claims 8, or 9, or 10, or 11, or 12, the method further comprising:
(a) correcting by the student of her error within a time limit after the error was made, thereby comprising a self-correction;
(b) calculation and storage of the number of self-corrections;
(c) including said self-corrections in the calculation of the test score.
